(19) United States
(12) Patent Application Publication
(10) Pub. No.: US 2013/0257592 A1
(43) Pub. Date: Oct. 3, 2013

(54) SYSTEMS AND METHOD FOR IDENTIFYING A STORAGE COMPARTMENT THAT IS ACCESSED

(71) Applicants: Douglas Johnson, Ambridge, PA (US); Darrin Roberts, Bradford Woods, PA (US); Jim Fisher, Zelienople, PA (US)

(72) Inventors: Douglas Johnson, Ambridge, PA (US); Darrin Roberts, Bradford Woods, PA (US); Jim Fisher, Zelienople, PA (US)

(73) Assignee: MCKESSON AUTOMATION INC., Cranberry, PA (US)

(21) Appl. No.: 13/435,916

(22) Filed: Mar. 30, 2012

(51) Int. Cl. G08B 5/22

(52) U.S. Cl. 340/6.1

(57) ABSTRACT

Methods, apparatuses and computer program products are provided for identifying which storage compartment of a plurality of storage compartments is moved from an inaccessible state to an accessible state. An apparatus according to example embodiments may include a plurality of storage compartments, each configured to transition from an inaccessible state to an accessible state. Each of the plurality of storage compartments may include a respective auditory generation device which may be configured to generate an audible tone in response to the associated storage compartment being transitioned from an inaccessible state to an accessible state. The apparatus of example embodiments may include a processing device configured to detect the audible tone and to identify the storage compartment transitioned from the inaccessible state to the accessible state in response to identifying the audible tone. The processing device may include a microphone configured to receive the audible tone.

### TECHNOLOGICAL FIELD

Embodiments of the present invention relate generally to storage devices and associated systems, and more particularly, using audible tones to identify a storage compartment that is accessed.

### BACKGROUND

Medication dispensing cabinets have been developed to store and controllably dispense a variety of medications. A medication dispensing cabinet may include a cabinet body with one or more drawers that are slideably disposed within the cabinet body. The drawers store the various medications. While some of the drawers may be unlatched and freely openable, other drawers may be locked in order to more closely control access to the medications stored in the locked drawers.

Some medication dispensing cabinets are automated and, as such, include or are otherwise associated with a computer that controls access to the compartments that store medications within the cabinet. The computer may be configured to allow access to only authorized users, such as pharmacists who stock the cabinet and medical providers who remove medications from the cabinet. Some medication dispensing cabinets may not include locks on individual medicine pockets, such that once a person has access to a drawer or tray of the cabinet, the medicines therein that are accessed may not be controlled.

The amount of time it takes for the medical provider to interact with the computer and access the respective drawer can vary based on the type of medication dispensing cabinets and their computer control systems. Locking drawers and individual medication pockets may provide greater control and monitoring of medications within the cart; however, such locking mechanisms may be costly to implement and may increase the level of interaction required, thereby taking more operator time and reducing efficiency. While medication storage cabinets are important tools in loss prevention of narcotics as well in providing the proper medication to each patient, any time spent interacting with the medication storage cabinets is time that the medical providers cannot be with their patients.

Accordingly, there is a need in the art for an improved system and method for dispensing medication that allows healthcare professionals to dispense medication for the patients under their care in a more rapid, efficient, and accurate manner.

### BRIEF SUMMARY

Methods, apparatuses and computer program products are provided according to embodiments of the present invention for identifying which storage compartment of a plurality of storage compartments is moved from an inaccessible state to an accessible state. An apparatus according to example embodiments of the invention may include a plurality of storage compartments, each configured to transition from an inaccessible state to an accessible state. Each of the plurality of storage compartments may include a respective auditory generation device which may be configured to generate an audible tone in response to the associated storage compartment being transitioned from an inaccessible state to an accessible state. The apparatus of example embodiments may include a processing device configured to detect the audible tone and to identify the storage compartment transitioned from the inaccessible state to the accessible state in response to identifying the audible tone. The processing device may include a microphone configured to receive the audible tone. One or more of the plurality of auditory generation devices may include a striker and a tine. One of the striker or the tine may be operably connected to the respective storage compartment, and in response to the storage compartment transitioning from an inaccessible state to an accessible state, the one of the striker or the tine may be moved into contact with the other of the striker or the tine.

The storage device of example embodiments may include a compartment with a door and transitioning from the inaccessible state to the accessible state may include moving the door from a closed position to an open position. A first component of the auditory generation device may strike a second component of the auditory generation device in response to moving the door from the closed position to the open position of a respective storage compartment. One of the first component or the second component may be a reed and the other of the first component or the second component may be a plucking device. One of the first component or the second component may be a striker and the other of the first component and the second component may be a tine. One or more of the plurality of storage compartments may be a drawer and transitioning from an inaccessible state to an accessible state may include sliding the drawer out from within a cabinet. The plurality of storage compartments may each be configured to generate an audible tone in response to the associated storage compartment being transitioned from the accessible state to the inaccessible state.

Example embodiments of the present invention may be configured to provide a method for identifying a storage compartment that is accessed including receiving a signal corresponding to an audible tone, associating the signal corresponding to the audible tone with a storage compartment of a plurality of storage compartments, and identifying the storage compartment that was accessed based upon an association of the audible tone with the storage compartment. The method may also include receiving an identity of a storage compartment that is to be accessed and providing confirmation that a correct storage compartment was accessed in response to the identity of the storage compartment that is to be accessed matching the identity of the storage compartment that was accessed. Methods may optionally include providing for an alert that the incorrect storage compartment was accessed in response to the identity of the storage compartment that is to be accessed not matching the identity of the storage compartment that was accessed.

Methods of example embodiments may further include receiving an audible tone corresponding to the storage compartment of the plurality of storage compartments indicating a closure of the storage compartment in response to the storage compartment closing. Example methods may include receiving the identity of a subsequent storage compartment that is to be accessed in response to receiving the audible tone indicating the closure of the storage compartment. According to this embodiment, the audible tone corresponding to the storage compartment indicating the closure of the storage compartment may be different from the audible tone corresponding to the storage compartment received in response to the user accessing the storage compartment. Associating the audible tone with a storage compartment may include referencing a database correlating audible tones with the identities of storage compartments.

According to some embodiments of the present invention an apparatus may be provided including a storage compartment, an auditory generation device configured to generate a first audible tone in response to the storage compartment moving from an inaccessible state to an accessible state, and configured to generate a second audible tone in response to the storage compartment moving from an accessible state to an inaccessible state. The apparatus may include a processing device configured to receive an electronic signal corresponding to one of the first audible tone or the second audible tone, where the processing device may be configured to identify the storage compartment based upon the first audible tone or the second audible tone. The processing device may further be configured to determine whether the storage compartment is in the accessible state or the inaccessible state in response to receiving an electronic signal corresponding to one of the first audible tone or the second audible tone. The processing device may be configured to provide an alert in response to the identified storage compartment not matching the identity of a storage compartment provided to a user.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a storage device in accordance with some example embodiments discussed herein;

FIG. 2 illustrates an example embodiment of a drawer of a storage device including a plurality of storage compartments disposed therein;

FIG. 3 illustrates an auditory generation device attached to a storage compartment according to example embodiments of the present invention;

FIG. 4 illustrates a block diagram of circuitry of an apparatus that may be included in some example embodiments discussed herein;

FIG. 5 illustrates an example embodiment of a plurality of storage compartments and a receiver according to the present invention;

FIG. 6 illustrates another example embodiment of a plurality of storage compartments and multiple receivers according to the present invention;

FIG. 7 is a flowchart outlining an example embodiment of a workflow implementing example embodiments of the present invention; and

FIG. 8 is a flowchart illustrating operations of a method that may be performed in accordance with example embodiments of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

The storage devices, systems, and methods of embodiments of the present invention may be used in any environment in which it is desirable to monitor access to storage locations. However, embodiments of the present invention are herein described with respect to healthcare facilities, such as hospitals, physicians' offices, healthcare clinics, and any other facility that manages and/or stores drugs and/or other materials for patient use.

Embodiments of the invention may be used to monitor access to drawers, trays, pockets, doors, or other locations which may be accessed through opening of a closure. Each of these drawers, trays, or pockets may generally be referred to as a “storage compartment” which may be configured to store an article, such as medication or supplies.

The storage devices, systems, and methods described herein can be configured to, for example, (1) indicate which storage compartment has been accessed by a user, (2) confirm if the correct storage compartment was accessed, (3) improve the speed of the workflow (e.g., the user's interactions with the storage device), and (4) reduce the likelihood of a user taking the wrong medication from the storage device, among other things. Further, although nurses are one example of a type of user (as they are often tasked with removing medication stored in an automated storage device) and examples with a nurse are sometimes used in the description that follows, it is understood that the described embodiments apply to any type of user who may interact with a storage device, including pharmacists, nurses, nurse technicians, pharmacy technicians, physicians, laboratory personnel, respiratory therapists, and others. Furthermore, although the examples of a user interfacing with a storage device for the purposes of removing medications are predominantly described below, one skilled in the art in light of this disclosure would recognize that the embodiments are also applicable to users interfacing with the automated storage device for the purpose of taking inventory, conducting counts of medications in the storage device (including, e.g., pocket-specific “blind counts”), stocking the storage device, and performing other tasks that may require access to the medication storage compartments in the automated storage device. In addition, the phrase “storage device” is intended to include any type of automated storage device, including automated dispensing cabinet (ADC), unit-based cabinet (UBC), automated dispensing device (ADD), automated distribution cabinet, medication dispensing cabinet, and automated dispensing machine (ADM), among others.

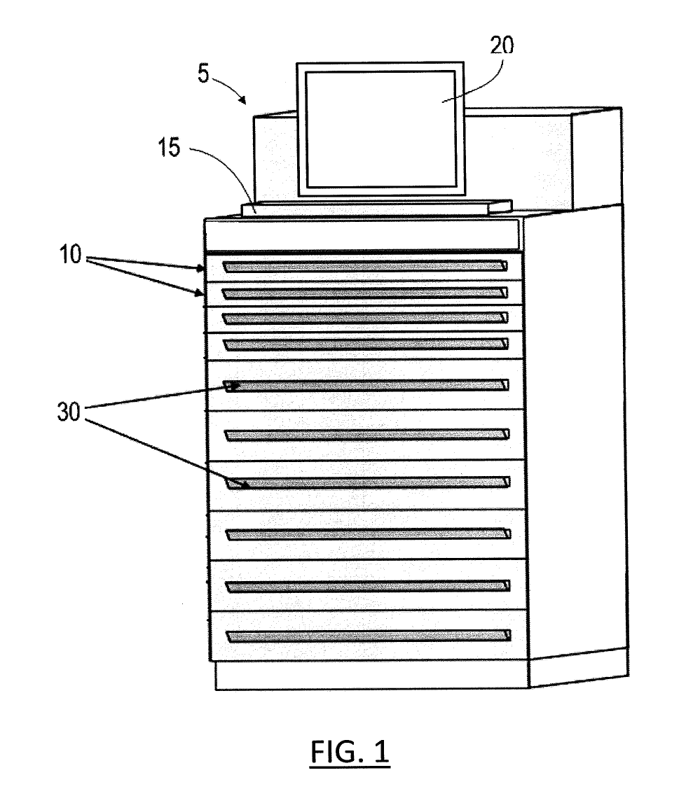

Turning now to FIG. 1, a storage device 5 is shown. For example, some embodiments of the storage device 5 can be similar to and/or include a component that are currently included in the cabinets sold and marketed as McKesson's AcuDose-Rx® and/or Anesthesia-Rx™. Example embodiments of the invention may also be implemented on mobile storage cabinets such as McKesson's CarePoint Connect™ product. The storage device 5 may be configured to store a number of different types and quantities of medications. In this regard, the storage device 5 may include (e.g., define) a plurality of drawers 10, examples of which are discussed below.

In addition, access to the drawers 10 may be restricted to certain authorized users and may further be accessible only when medication stored in the particular drawer is to be removed, stocked and/or counted, as described in greater detail below. For example, each drawer 10 may be in a locked state until an authorized user interfaces with the storage device 5 to select for removing a particular medication stored within a particular drawer, at which point the storage device may unlock and/or open the drawer containing the selected medication to allow the user's access.

The drawers 10 may hold more than just medications, in some cases. For example, certain medical accessories or supplies may also be stored in the automated storage device 5, such as applicators, syringes, keys, prescription pads, cameras, etc., which may also be dispensed, stocked, and/or otherwise handled by the user during an interaction with the storage device 5. Accordingly, although the examples provided below refer to the removal of medications, the dispensing, stocking, transport, counting and/or other type of handling of any item stored in the storage device 5, such as medical accessories, is contemplated herein.

In some embodiments, the storage device 5 can further include various data and/or user input devices, such as input device 15. A data input device may be, for example, a device that receives data from another machine, such as communications modules discussed below, and an user input device may include devices configured to receive inputs from the user, such as touch displays, keyboards, cameras, touchpads, and computer mice, among other things. User input device 15 and display device 20 are shown in FIG. 1, wherein user input device 15 is shown as a keyboard and display device 20 is shown as a touch-sensitive display device.

The user and data input devices can be used to facilitate, among other things, removal transactions. In this regard, the phrase “removal transaction” is used herein to describe the interfacing between the user and the storage device to remove one or more medications to be administered to a single patient. Thus, each removal transaction is associated with a particular selected patient. Furthermore, each user may have multiple removal transactions with the storage device in a single interaction with the storage device. In this regard, the window between the time a user logs into the system (e.g., provides identification credentials indicating that the user is authorized to have access to the medications stored within the storage device) to the time the user logs out of the system (which may require, e.g., a log-out event by the same user or resulting from an expiration of a predetermined period of time, or a log-in event by a different user for access to the storage device) may define the interaction, whereas the time it takes for the user to remove medications relating to a particular patient may define the removal transaction.

A user may conduct multiple removal transactions for one or more patients in a single user interaction with the storage device, and the storage device 5 can be configured to identify which storage compartments may be accessed with each removal transaction, as discussed below. Additionally or alternatively, the storage device 5 can be configured to create a record of access to one or more storage compartments associated with any other type(s) of transaction, including counting transaction, stocking transaction, etc. Further, according to embodiments of the present invention, the storage device 5 may be configured to provide confirmation of the appropriate storage compartment being accessed or alert a user that the improper storage compartment has been accessed.

Additionally, some embodiments of the storage device 5 may include display device 20, which may include a monitor, as depicted in FIG. 1, and may be configured to present various user-understandable information. The display device 20 may include one or more display screens that may also be configured to function as input devices, as noted above. For example, display device 20 may include touch-sensitive components and associated hardware, software and/or firmware. The storage device 5 of example embodiments may further include output components such as lights (LEDs, etc.), audio speakers, haptic feedback components, and/or any other component that may generate stimuli detectable by a user.

As such, the user input and output devices may be configured to help facilitate particular removal, stocking and/or counting transactions. For example, a user input device may receive input in the form of identification credentials authorizing the user to access the storage device 5 and/or a particular drawer 10 of the storage device 5; a selection of a patient for whom medication is to be dispensed; a request for information regarding a particular medication stored in one of the storage compartments or a particular patient to whose records the user has access; a selection of a particular medication to be viewed or dispensed; and so on. User output devices may then help direct the user to the appropriate storage compartment (e.g., drawer, pocket, and/or any other medication storage component of the storage device 5) from which the medication can be removed.

In an example embodiment, using the display device 20, the user may be able to view a list of patients under the user's care; view patient details (e.g., patient's name, date of birth, medical condition, allergies, date of admittance, date of expected discharge, etc.); view a list of prescribed medications for a particular patient; view medication details (such as potential interactions, medication properties, and dosage information); and/or view order details (such as the name of a medication, required dosage, quantity to be dispensed, portion of the medication in the storage device, etc.). Some or all of the user's interactions at the storage device 5 may be monitored at a remote machine and/or recorded at the storage device and/or at a remote machine.

Different types of storage devices 5 may include different sizes and styles of drawers 10, depending on, for example, the types of medications to be stored in the drawers 10, the quantities required (which may be dictated by the size or type of the facility or other area serviced by the automated storage device), and user preferences. For example, as shown in FIG. 1, some of the drawers 10 may be relatively deep (e.g., drawers 30), whereas others may be relatively shallow. As another example, the number, arrangement and size of the pockets and/or other types of storage type compartment(s) included in one of the drawers 10 may be different than that included in another of the drawers 10.

Additionally or alternatively, each storage compartment may also be locked with a closure or lid that the storage device 5 can be configured to unlock only when medication stored in the particular pocket is to be dispensed, restocked and/or counted. For example, each drawer 10 and/or compartment may be in a locked state until an authorized user interfaces with the storage device 5 to access a particular drawer, pocket and/or other storage compartment, at which point the storage device may unlock and/or open the closure of the compartment to allow the user's access. In some embodiments, a drawer (e.g., drawer 10) may be configured to be lockable while individual storage compartments within the drawer may not be lockable.

Storage compartments of example embodiments, may be configured to be moved between an accessible state and an inaccessible state. In the example embodiment of the storage compartment being a drawer, the drawer in a closed position, relative to a cabinet or housing, may be in the inaccessible state. When the drawer is drawn out of the cabinet or housing, the drawer may be in the accessible state. Similarly, in the example embodiment where the storage compartment is a bin or a pocket with a lid closure, when the closure is in a closed position, the storage compartment is in an inaccessible state. When the closure is open, allowing access to the contents of the storage compartment, the storage compartment is in the accessible position.

In some embodiments, one or more auditory generation devices may be associated with each storage compartment, as described in detail below. The auditory generation devices according to example embodiments may be configured to generate an audible tone in response to the storage compartment to which they are associated being accessed.

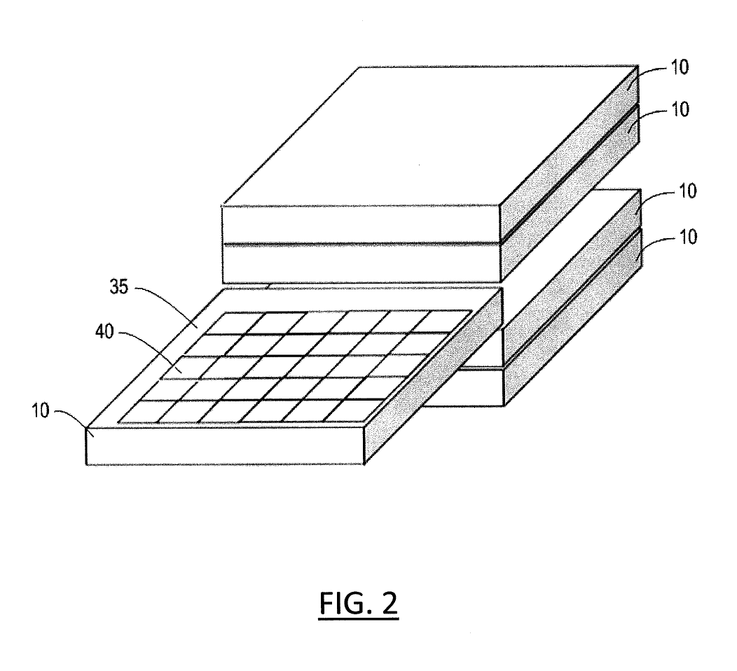

Storage compartments, as described herein, may include pockets, drawers, trays, compartments, or the like. Further, storage compartments, such as drawers, may include a plurality of storage compartments disposed within the drawer. FIG. 2 illustrates a series of drawers 10 which may be received by a storage device, such as the storage device 5 of FIG. 1. Each drawer 10 may include storage compartments, such as the illustrated storage pockets 40 of open drawer 35. Accessing a storage compartment may include opening of a drawer or opening of a door, lid, or similar closure to a storage pocket.

Each storage compartment within a storage device 5 may be identified by some identifying indicia, which may be alpha-numeric, symbolic, color coded, or the like. Optionally, storage compartments may be configured with a display which may present identifying information to a user, such as a medication name or storage compartment identifier. Further, storage compartments may include an indicator, such as an LED or similar indicator which may be used to correlate information presented on a display (e.g., display 20) with an indicated storage compartment. Storage compartments, such as the storage pockets 40 of drawer 35 of FIG. 2, may be identified by row numbers and column numbers or they may be individually identified by indicia located on each storage pocket. Identification of each storage compartment may be important in loading medication into the storage compartments and when accessing each storage compartment for medication retrieval.

As noted above, each storage compartment of storage devices of example embodiments may include an auditory generation device. Auditory generation devices according to example embodiments may use a variety of mechanisms by which an audible tone may be generated. For example, auditory generation devices of example embodiments may include a tine and a striker, configured such that when the striker strikes the tine, an audible tone is generated. Conversely, the tine may be struck against the striker to generate the audible tone. Further auditory generation devices may include a reed that is plucked, two reeds that are plucked together, a bell that is struck, or a string that is plucked. Auditory generation devices may further include a striker that engages a series of ridges, such as a washboard, to create a pulse of sounds.

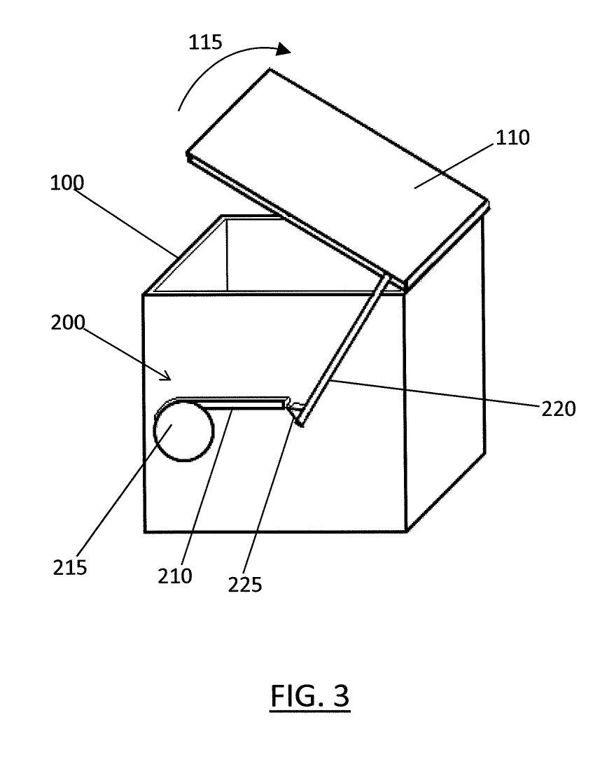

Each of the aforementioned auditory generation devices may be used with example embodiments of storage devices described herein. Storage compartments within the storage device may each be associated with or operatively connected to an auditory generation device. The auditory generation device associated with a storage compartment may be triggered (e.g., caused to generate an audible tone) in response to the storage compartment being accessed. For example, a striker may be moved relative to a tine in response to the lid of a storage compartment opening. FIG. 3 illustrates an example embodiment of a storage compartment 100 including an auditory generation device 200. The storage compartment 100 is illustrated absent an environment which may be a plurality of similar storage compartments or it may be a drawer or tray of a storage device. Each storage compartment within such a storage device may be configured with the same or different types of auditory generation devices; however, not all storage compartments may include an auditory generation device. For example, if each storage compartment pocket 40 of the drawer 35 of FIG. 2 has an auditory generation device, the drawer 35 may not require an auditory generation device.

Referring back to FIG. 3, the auditory generation device of the illustrated embodiment includes a tine 210 which may be attached to the storage compartment as illustrated or the tine 210 may be otherwise attached to the storage device. The tine 210 may be attached via a securing means 215 that does not inhibit the vibrations of the tine 210. Optionally, the securing means 215 may be configured to amplify the audible tone emitted by the tine 210, for example with a diaphragm or other structure adapted to resonate at the resonant frequency of the tine 210. The striker 220 may be attached to a closure 110 (e.g., a lid or a door) of the storage compartment and may move together with the closure 110. In the illustrated embodiment, movement of the door in an arc illustrated by arrow 115 causes the head 225 of the striker 220 to strike the tine 210. Upon the head 225 of the striker 220 striking the tine 210, the tine 210 may resonate at the designed resonant frequency, thereby generating an audible tone. While the illustrated embodiment depicts the striker 220 attached to the door 110, the striker may be indirectly coupled to the door in any fashion which facilitates relative motion between the striker 220 and the tine 210 in response to the door 110 opening.

Example embodiments of the auditory generation device may include auditory generation devices configured to produce or generate a first audible tone in response to a storage compartment being moved from the inaccessible state (e.g., a closed state) to the accessible state (e.g., an open state), and a second audible tone in response to the storage compartment being moved from the accessible state to the inaccessible state. Optionally, the auditory generation device may be configured to produce two tones in response to being moved to an accessible state. The two tones may be different such that when the tones are received by the receiver in a first order, it is an indication that the storage compartment has been accessed. When the tones are received by the receiver in a second order (e.g., a reversal of the first order), it may be an indication that the storage compartment has been closed.

Further examples of auditory generation devices may include a striker configured to ride over a series of ridges as the closure of the storage compartment is moved from the inaccessible state to the accessible state. In such an example embodiment, the number of ridges, the space between the ridges, and the height of the ridges may each contribute to the audible tone. For example, taller ridges may elicit a louder sound when the striker passes over them. Ridges at the beginning or end of the series of ridges may be configured with a different profile than ridges between the beginning and end such that a processing device may be able to distinguish the beginning of an audible tone and the end of an audible tone emitted by the auditory generation device of a storage compartment. The beginning and ending ridges may also permit a processing unit to determine an opening versus a closing of the closure of the storage compartment.

In an example embodiment, each storage compartment 40 of drawer 35 of FIG. 2 may be configured with an auditory generation device. Each auditory generation device may be configured to generate an audible tone. The drawer 35 may be configured with one or more devices, such as a microphone, configured to receive the audible tone and transmit the audible tone or a signal representing the audible tone to a processing device. The processing device may then identify the audible tone that was received by the receiver.

Each auditory generation device together with the processing device may be configured to distinguish and identify the storage compartment that is accessed. For example, the auditory generation device of each compartment may be configured to generate a different audible tone. The audible tone may be translated to a signal at the receiver, the signal may then be transmitted to the processing device where the signal is identified by the processing device. The processing device may then identify the storage compartment that was accessed to generate the audible tone. Further examples of identifying the storage compartment accessed are described below.

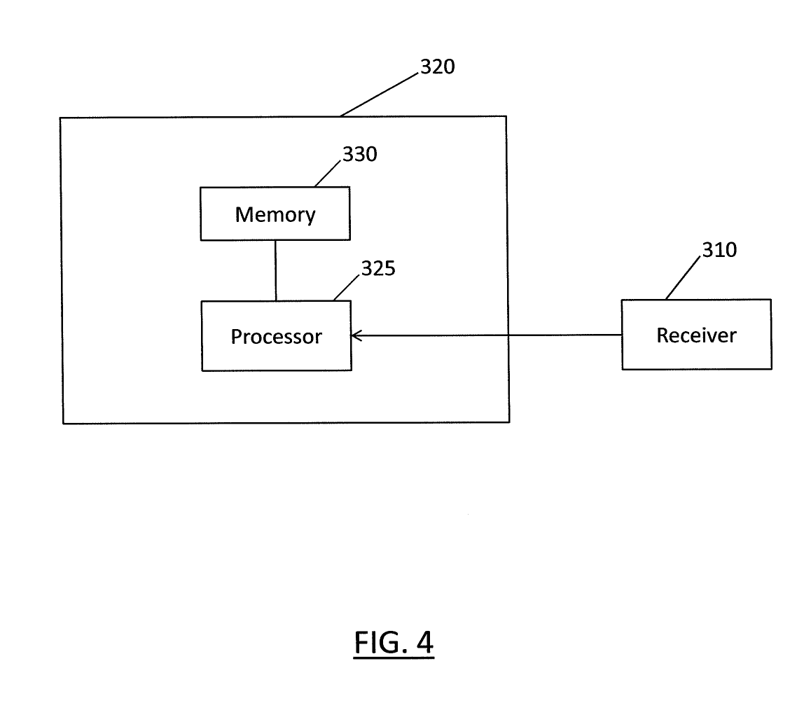

An example embodiment of the processing device is illustrated in FIG. 4 which illustrates the device configured to receive the audible tone identified as the receiver 310. The receiver may include any suitable means for receiving an audible tone and converting the audible tone into a signal to be sent to the processing device 320. The receiver may be an acoustic-to-electric transducer or sensor that converts sound into an electrical signal. The signal may be produced by electromagnetic induction, capacitance change, piezoelectric generation, light modulation, or any suitable mechanism for converting an acoustic signal into an electrical signal for transmission to the processing device 320.

The processing device 320 may include processor 325 that may, for example, be embodied as various means including one or more microprocessors with accompanying digital signal processor(s), processor(s) without an accompanying digital signal processor, one or more coprocessors, multi-core processors, controllers, computers, various other processing elements including integrated circuits such as, for example, an ASIC (application specific integrated circuit) or FPGA (field programmable gate array), or some combination thereof. Accordingly, although shown in FIG. 4 as a single processor, in some embodiments the processor 325 comprises a plurality of processors and/or any other type of control circuitry. The plurality of processors, for example, may be embodied on a single computing device or may be distributed across a plurality of computing devices collectively configured to function as the processor 325. The plurality of processors may be in operative communication with each other and may be collectively configured to perform one or more functionalities of the processor 325 as described herein. In an example embodiment, the processor 325 is configured to execute instructions stored in the memory 330 and/or that are otherwise accessible to the processor 325.

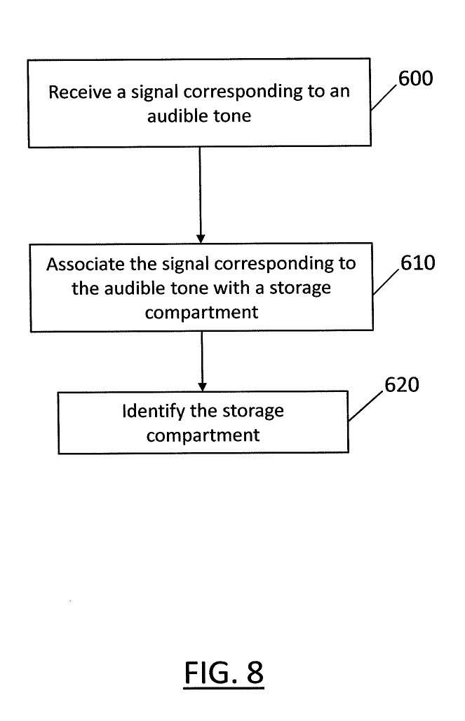

The memory 330 can be in communication with and/or included in the processor 325. The memory 330 may comprise volatile and/or non-volatile memory that stores content, data and/or any other information. For example, the memory 330 can store information generated by, transmitted from, the receiver 310. Also for example, the memory 330 can store software applications, firmware, instructions and/or the like for the processor 325 to perform steps associated with operation of the receiver 310. For example, the memory 330 may be a non-transitory storage medium that stores computer program code comprising instructions or other executable portions that the processor 325 executes to perform the steps described above and below with regard to, e.g., FIG. 8.

As such, whether configured by hardware, firmware/software methods, or by a combination thereof, the processor 325 may comprise an entity capable of performing operations according to embodiments of the present invention while configured accordingly. Thus, for example, when the processor 325 is embodied as an ASIC, FPGA or the like, the processor 325 may comprise specifically configured hardware for conducting one or more operations described herein. Alternatively, as another example, when the processor 325 is embodied as an executor of instructions, such as may be stored in the memory 330, the instructions may specifically configure the processor 325 to perform one or more algorithms and operations described herein.

In other embodiments, one or more of the components shown in FIG. 4 (and/or any other drawing discussed herein) may be omitted and/or the functionality associated therewith may be performed by another component discussed herein. Further, the functions described herein with respect to the processing device 320 and the components thereof may be performed by the processing device controlling the input device 15 and display 20 of FIG.1. In that regard, example embodiments of the present invention may be configured to be retrofit into existing automated storage devices and to utilize the existing processing abilities of a capable processor of the automated storage device. To that end, functions described herein with regard to FIG. 4 may be construed as being performed by a controller of the automated storage device or by a separate processing device.

As noted above, the receiver 310 may be configured to receive the audible tone and the processing device 320 may be configured to receive an electric signal corresponding to the audible tone from the receiver 310. The processing device 320 may then be capable of determining the audible tone (e.g., the frequency of the tone, the number of pulses of the tone, etc.) and identifying the storage compartment associated with that audible tone. While some example embodiments may include a different audible tone for each storage compartment, further example embodiments may identify storage compartments through methods that do not exclusively rely upon the audible tone.

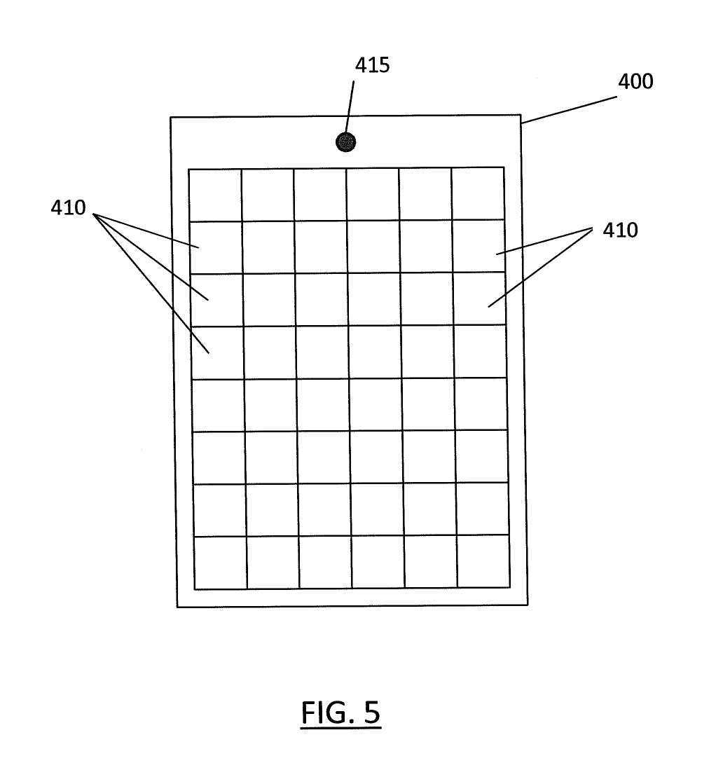

An example embodiment of the present invention is illustrated in FIG. 5 which depicts a drawer 400 including a plurality of storage compartments 410. In the illustrated embodiment, each of the storage compartments 410 is approximately the same size; however, storage compartments may be of any shape or size. Each storage compartment 410 may include an auditory generation device configured to generate an audible tone in response to the respective storage compartment 410 being accessed. The drawer 400 may be configured with a receiver 415 configured to receive the audible tones from the auditory generation devices of each of the storage compartments 410. The depicted receiver 415 may be disposed within the drawer and not visible when viewing the storage compartments 410 of the drawer. The depiction of the receiver 415 is merely for relative positioning of the receiver 415 within the drawer 400. Optionally, there may be multiple receivers arranged in various locations of the drawer 400 to ensure each audible tone is properly received.

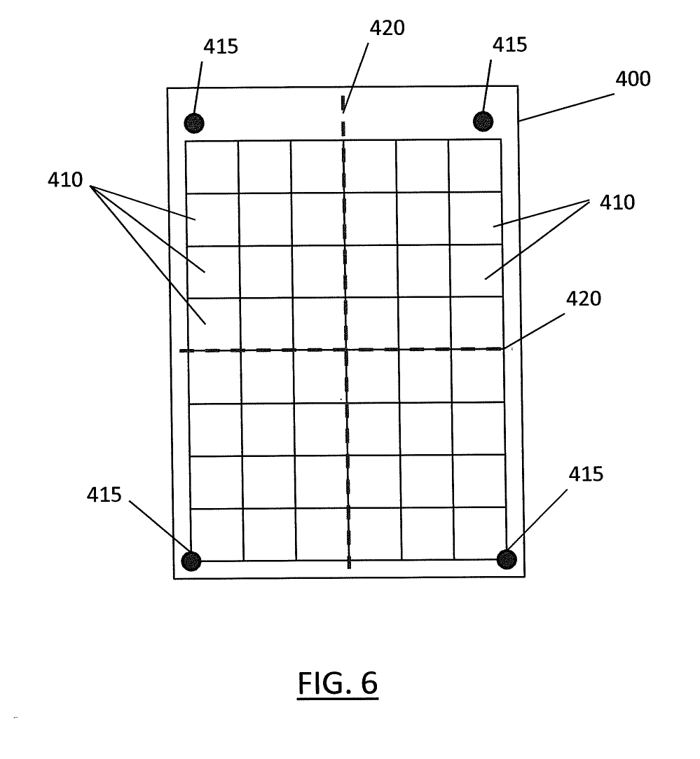

FIG. 6 illustrates another example embodiment of a drawer 400 with storage compartments 410. In the embodiment of FIG. 6, four receivers 415 are disposed within the drawer 400, each proximate a respective corner. The drawer 400 may include sound barriers 420 between certain storage compartments 410 configured to isolate each of the groups of storage compartments. In the illustrated embodiment, there are four isolated areas of storage compartments. Each receiver may be configured to receive audible tones from only those storage compartments (and respective auditory generation devices) within their particular area. As such, rather than 48 different auditory generation devices configured to generate 48 different audible tones, each of twelve different auditory generation devices may be used four times, once in each area. Each receiver may be configured to identify the area to which it is associated such that a signal received at a processing device from a receiver may include an area of the drawer 400 and an audible tone from a storage compartment 410 within that area.

The drawers of the embodiments of FIGS. 5 and 6 may include a cavity that permits the audible tone to travel within the drawer to the receiver 415. The drawers 400 may be acoustically insulated such that the audible tone is sensed by the receiver 415, but not substantially audible outside of the drawer 400. Optionally, drawers or automated storage devices including storage compartments may include an acoustic channel configured to transmit the audible tone from the storage compartments to the receivers. Such acoustic channels may be configured to efficiently reflect the audible tone for accurate reception by the receiver 415.

While the above example embodiments include a receiver disposed within a drawer of the automated storage device, example embodiments may include one or more receivers disposed within the automated storage device housing which is configured to receive the drawers. In such an example embodiment, each drawer may be configured with a sound conducting channel configured to conduct audible tones of storage compartments within the drawer to an area of the housing of the automated storage device in which the receiver is located. Such an embodiment may not require electrical connections to be made between the drawer and the automated storage device in order to determine the storage compartment that was accessed.

As noted above, in some example embodiments the auditory generation device may be configured to generate a first tone when the storage compartment is moved from the inaccessible state to an inaccessible state, and a second tone when the storage compartment is moved from the accessible state to an inaccessible state. Embodiments of the invention may be configured to identify when a specific storage compartment is opened and when the storage compartment is closed. Optionally, embodiments in which a single tone is emitted when the storage compartment is opened and closed, every odd occurrence of the tone may be interpreted as an “opening” (e.g., the storage compartment moving from the inaccessible state to the accessible state) and every even occurrence of the tone may be interpreted as a “closing” (e.g., the storage compartment moving from the accessible position to the inaccessible position).

Embodiments of the present invention have been described with regard to the identification of a particular storage compartment which has been accessed. Identifying which storage compartment has been accessed may be important for ensuring that the proper medication is retrieved, ensuring that the proper medication is stocked, increasing the efficiency with which medication is stocked, and discouraging medication theft among other reasons. Examples of workflow using embodiments of the present invention are described below to further clarify benefits of the present invention.

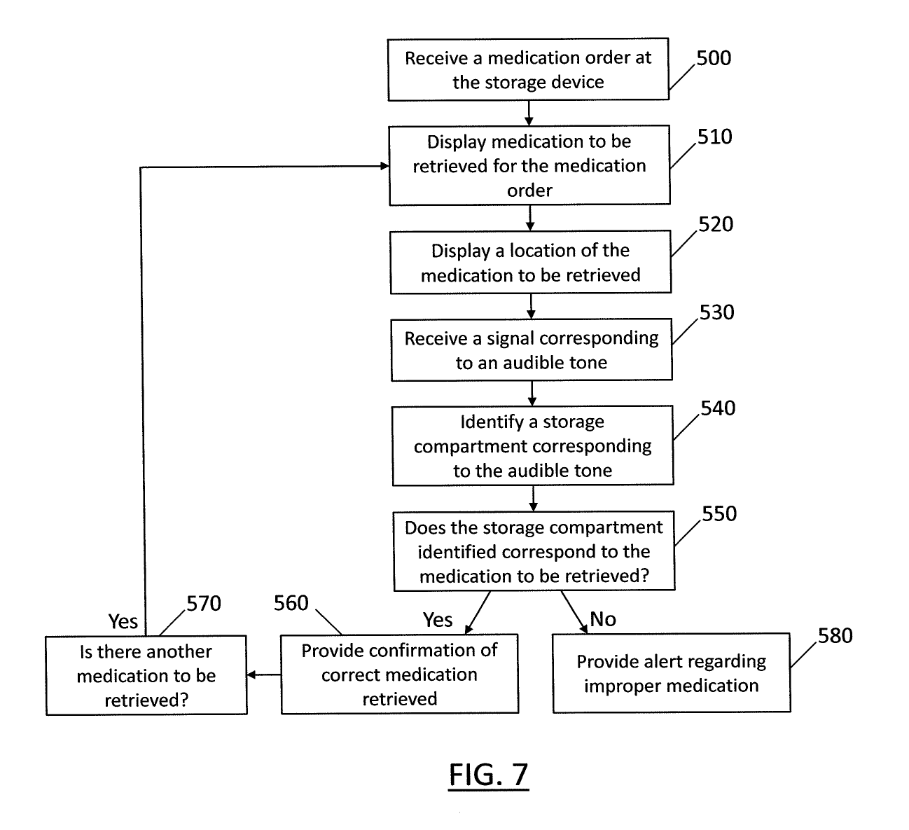

FIG. 7 illustrates an example embodiment of a process which may benefit from example embodiments of the present invention. The process begins at 500 where an automated storage device, such as the device 5 of FIG. 1, may receive a medication order. The medication order may come, for example, from a healthcare network entity or may be manually entered by an operator. The first medication to be retrieved for the medication order may be displayed, for example on display 20 of FIG. 1, at 510. The location of the medication may be displayed at 520. The location may be presented on the display 20 and/or it may be presented by identifying the storage compartment (e.g., via an LED disposed on or adjacent to the storage container). Optionally, the location may be displayed by projection of a light onto the appropriate storage container. The user may then retrieve the medication from the identified storage compartment. In retrieving the medication, the user may open a closure for the compartment, thereby actuating the auditory generation device associated with the compartment. The audible tone generated by the auditory generation device may be received by the receiver and an electrical signal corresponding to the audible tone may be sent to the processing device. The processing device may then determine the storage compartment associated with the audible tone, for example, through a lookup table, which may be stored, for example, in memory 330. At 550, the processing device determines if the identified storage compartment corresponds to the storage compartment containing the medication to be retrieved. If the storage compartments correspond, a confirmation of retrieval of the correct medication may be provided at 560. If the storage compartments do not correspond, indicating that the user accessed the incorrect storage compartment, an alert may be generated at 580. At 570, a determination may be made as to whether there are more medications to be retrieved and the process may begin again at 510.

The example workflow described with respect to the flowchart of FIG. 7 may help reduce errors in filling medication orders by providing confirmation of retrieval of the correct medication, or an alert indicating retrieval of the incorrect medication. Further workflow examples may expedite the loading or stocking of a medication cabinet. For example, a user may stock a medication cabinet by scanning identifying indicia of a medication at the user interface of a medication cabinet. The scanning of identifying indicia may be performed by using a barcode scanner to scan a barcode or similar identification mechanism. Upon successfully scanning a medication, the display may provide information regarding the medication. A user may open a drawer (e.g., drawer 10 of storage device 5) and open a storage compartment of the drawer (e.g., compartment 40 of drawer 35 of FIG. 2). The auditory generation device associated with the opened storage compartment may generate an audible tone which is received by the receiver (e.g., receiver 310) and a signal is sent to processing device (e.g., processing device 320). The processing device may then identify which compartment was opened, and correlate the scanned medication with the opened compartment, storing the correlation for use in subsequent retrieval of the medication.

While FIG. 7 is a flowchart of an example embodiment of workflow using embodiments of the present invention, FIG. 8 is a flowchart of a method of identifying which of a plurality of storage compartments are accessed. In this regard, a processing device according to one embodiment of the invention, as shown in FIG. 4, may include means, such as the processor 325, for receiving a signal corresponding to an audible tone at 600. The audible tone may be generated by an auditory generation device as described above, received by a receiver, and sent as a signal to the processing device. The signal corresponding to the audible tone may be associated with a storage compartment at 610. The storage compartment corresponding to the audible tone may be identified at 620. The processing device may identify the storage compartment corresponding to the audible tone by using a lookup table or similar mechanism to correlate the audible tone to a storage compartment.

FIG. 8 shows processes 600-620, which may be used in accordance with some embodiments to identify which storage compartment of a plurality of storage compartments is accessed, such as storage compartment 40 of drawer 35discussed herein. Processes 600-620 are represented by flow diagrams in accordance with some exemplary methods, computer program products and/or systems discussed herein. It will be understood that each operation, action, step and/or other types of functions shown in the diagrams, and/or combinations of functions in the diagrams, can be implemented by various means. Means for implementing the functions of the flow diagrams, combinations of the actions in the diagrams, and/or other functionality of example embodiments of the present invention described herein, may include hardware and/or a computer program product including a computer-readable storage medium (as opposed to or in addition to a computer-readable transmission medium) having one or more computer program code instructions, program instructions, or executable computer-readable program code instructions stored therein. For example, program code instructions associated with FIG. 8 may be stored on one or more storage devices, such as memory 330, and executed by one or more processors, such as processor 325. Additionally or alternatively, one or more of the program code instructions discussed herein may be stored and/or performed by distributed components, such as those that may be connected to automated storage device 5 via a network or other communications interface. As will be appreciated, any such program code instructions may be loaded onto computers, processors, other programmable apparatuses (e.g., automated storage device 5) or network thereof from one or more computer-readable storage mediums to produce a particular machine, such that the particular machine becomes a means for implementing the functions of the actions discussed in connection with, e.g., FIG. 8 and/or the other drawings discussed herein.

The program code instructions stored on the programmable apparatus may also be stored in a non-transitory computer-readable storage medium that can direct a computer, a processor (such as processor 325) and/or other programmable apparatus to function in a particular manner to thereby generate a particular article of manufacture. The article of manufacture becomes a means for implementing the functions of the actions discussed in connection with, e.g., FIG. 8. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel by one or more machines, such that multiple instructions are retrieved, loaded, and/or executed together. Execution of the program code instructions may produce a computer-implemented process such that the instructions executed by the computer, processor, other programmable apparatus, or network thereof provides actions for implementing the functions specified in the actions discussed in connection with, e.g., processes 600-620 of FIG. 7.

In this regard, embodiments discussed herein can assist in identifying a storage compartment of a storage device that is moved from an inaccessible state (e.g., closed) to an accessible state (e.g., open). Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A storage device comprising:
a plurality of storage compartments, each configured to transition from an inaccessible state to an accessible state;
a plurality of auditory generation devices, each associated with a respective one of the plurality of storage compartments and configured to generate an audible tone in response to the associated storage compartment being transitioned from the inaccessible state to the accessible state; and
a processing device configured to detect the audible tone and to identify the storage compartment transitioned from the inaccessible state to the accessible state in response to identifying the audible tone.

2. The storage device of claim 1, wherein the processing device comprises a microphone configured to receive the audible tone.

3. The storage device of claim 1, wherein one or more of the plurality of auditory generation devices comprises a striker and a tine.

4. The storage device of claim 3, wherein one of the striker or the tine are operably connected to the respective storage compartment and wherein in response to the storage compartment transitioning from an inaccessible state to an accessible state, the one of the striker or the tine are moved into contact with the other of the tine or the striker.

5. The storage device of claim 1, wherein at least one of the plurality of storage compartments comprises a compartment with a door, and wherein transitioning from the inaccessible state to the accessible state comprises moving the door from a closed position to an open position.

6. The storage device of claim 5, wherein a first component of the auditory generation device strikes a second component of the auditory generation device in response to moving the door from the closed position to the open position of a respective storage compartment.

7. The storage device of claim 6, wherein one of the first component or the second component is a reed and the other of the first component or the second component is a plucking device.

8. The storage device of claim 6, wherein one of the first component or the second component is a tine and the other of the first component or the second component is a striker.

9. The storage device of claim 1, wherein one or more of the plurality of storage compartments is a drawer and transitioning from an inaccessible state to an accessible state comprises sliding the drawer out from within a cabinet.

10. The storage device of claim 1, wherein the plurality of storage compartments are each further configured to generate an audible tone in response to the associated storage compartment being transitioned from the accessible state to the inaccessible state.

11. A method of identifying which of a plurality of storage compartments is accessed, the method comprising:
receiving a signal corresponding to an audible tone;
associating the signal corresponding to the audible tone with a storage compartment of the plurality of storage compartments; and
identifying the storage compartment that was accessed based upon an association of the audible tone with the storage compartment.

12. The method of claim 11, further comprising:
receiving an identity of a storage compartment that is to be accessed; and
providing confirmation that a correct storage compartment was accessed in response to the identity of the storage compartment that is to be accessed matching the identity of the storage compartment that was accessed.

13. The method of claim 12, further comprising:
providing for an alert that the incorrect storage compartment was accessed in response to the identity of the storage compartment that is to be accessed not matching the identity of the storage compartment that was accessed.

14. The method of claim 12, further comprising receiving an audible tone corresponding to the storage compartment of the plurality of storage compartments indicating a closure of the storage compartment in response to the storage compartment closing.

15. The method of claim 14, further comprising receiving the identity of a subsequent storage compartment that is to be accessed in response to receiving the audible tone indicating the closure of the storage compartment.

16. The method of claim 14, wherein the audible tone corresponding to the storage compartment indicating the closure of the storage compartment is different from the audible tone corresponding to the storage compartment received in response to a user accessing the storage compartment.

17. The method of claim 11, wherein associating the audible tone with a storage compartment comprises referencing a database correlating audible tones with identities of storage compartments.

18. An apparatus comprising:
a storage compartment;
an auditory generation device configured to generate a first audible tone in response to the storage compartment moving from an inaccessible state to an accessible state, and configured to generate a second audible tone in response to the storage compartment moving from an accessible state to an inaccessible state;
a processing device configured to receive an electronic signal corresponding to one of the first audible tone or the second audible tone, wherein the processing device is configured to identify the storage compartment based upon the first audible tone or the second audible tone.

19. The apparatus of claim 18, wherein the processing device is further configured to determine whether the storage compartment is in the accessible state or the inaccessible state in response to receiving an electronic signal corresponding to one of the first audible tone or the second audible tone.

20. The apparatus of claim 18, wherein the processing device is further configured to provide an alert in response to the identified storage compartment not matching the identity of a storage compartment provided to a user.
